(19) United States
(12) Patent Application Publication
(10) Pub. No.: US 2010/0089712 A1
(43) Pub. Date: Apr. 15, 2010

(54) PROJECTION ASSEMBLY AND LITHOGRAPHIC APPARATUS

(75) Inventors: Hans Butler, Best (NL); Cornelius Adrianus,Lambertus De Hoon, Best (NL)

Correspondence Address: PILLSBURY WINTHROP SHAW PITTMAN, LLP, P.O. BOX 10500, MCLEAN, VA, 22102, US

(73) Assignee: ASML Netherlands B.V., Veldhoven (NL)

(21) Appl. No.: 12/574,573

(22) Filed: Oct. 6, 2009

Related U.S. Application Data
(60) Provisional application No. 61/103,421, filed on Oct. 7, 2008.

(51) Int. Cl. F16F 7/10; G03B 27/42

(52) U.S. Cl. 188/378; 355/53

(57) ABSTRACT

A projection assembly includes a projection system to project a patterned radiation beam onto a substrate, a damping system to dampen a vibration of the projection system, the damping system including an interface damping mass and an active damping subsystem to dampen a vibration of at least part of the interface damping mass, the interface damping mass connected to the projection system, the active damping subsystem including a sensor to measure a position of the interface damping mass, an electromagnetic actuator to exert a force on the interface damping mass, and a controller to drive the electromagnetic actuator based on a signal provided by the sensor, the active damping subsystem including a reaction mass for the electromagnetic actuator to exert a counterforce upon based on the signal provided by the first sensor.

### CROSS REFERENCE TO RELATED APPLICATIONS

This application claims priority and benefit under 35 U.S.C. §119(e) to U.S. Provisional Patent Application No. 61/103,421, entitled “Projection Assembly and Lithographic Apparatus”, filed on Oct. 7, 2008. The content of that application is incorporated herein in its entirety by reference.

### FIELD

The present invention relates to a projection assembly and a lithographic apparatus, each including a damper configured to dampen vibrations of at least part of the projection assembly and the lithographic apparatus respectively.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to provide high accuracy and high resolution in lithography, it is desirable to accurately position parts of the lithographic apparatus such as the patterning device (e.g. reticle) stage to hold the patterning device (e.g. mask), the projection system and the substrate table to hold the substrate, with respect to each other. Apart from positioning of e.g. the patterning device stage and the substrate table, this also poses requirements on the projection system. The projection system in current implementations may consist of a carrying structure, such as a lens mount (in case of transmissive optics) or a mirror frame (in case of reflective optics) and a plurality of optical elements such as lens elements, mirrors, etc. In operation, the projection system may be subject to vibrations due to a plurality of causes. As an example, movements of parts in the lithographic apparatus may result in vibrations of a frame to which the projection system is attached, a movement of a stage such as the substrate stage or the patterning device stage, or accelerations/decelerations thereof, which may result in a gas stream and/or turbulence and/or acoustic waves affecting the projection system. Such disturbances may result in vibrations of the projection system as a whole or of parts thereof. By such vibrations, displacements of lens elements or mirrors may be caused, which may in turn result in an imaging error, i.e. an error in the projection of the pattern on the substrate.

The projection system housing may, due to external forces, such as forces caused by mechanical vibrations, acoustics, air flows, be excited at the eigenfrequencies of one or more lens elements arranged in the projection system housing. The resulting movements of the projection system' housing will be taken into account in the servo control loop of the substrate and/or patterning device support, which attempts to position the support with respect to the projection system housing. However, the frequency with which the projection system housing vibrates may be too high for the support to follow, hence inducing imaging errors because the relative position of the support and the projection system housing is not according to the desired position. Alternatively, an increased settling time of the servo systems could be used to wait until the projection system housing stops vibrating, which settling time would have to be large since these lens elements are mounted in the projection system housing with a mounting having a low damping. As a result, the overall throughput of the lithographic apparatus is negatively influenced.

### SUMMARY

It is desirable to provide a projection assembly wherein the bandwidth for which vibrations of the projection system or parts thereof can be damped, is increased. It is further desirable to provide a lithographic apparatus in which the imaging accuracy and/or the throughput is improved.

According to an embodiment of the invention, there is provided a projection assembly including a projection system configured to project a patterned radiation beam onto a target portion of a substrate, a damper configured to dampen a vibration of at least part of the projection system, the damper including an interface damping mass and an active damping subsystem configured to dampen a vibration of at least part of the interface damping mass, the interface damping mass being connected to the projection system, the active damping subsystem including a first sensor configured to measure a position quantity of the interface damping mass, an electromagnetic actuator configured to exert a force on the interface damping mass, and a controller configured to drive the electromagnetic actuator in dependency of a signal provided by the first sensor, the active damping subsystem including a reaction mass for the electromagnetic actuator configured to exert a counterforce upon in dependency of signals provided by the first sensor, wherein the controller is arranged to provide a substantially voltage control of the electromagnetic actuator in a first frequency range, and a substantially current control of the electromagnetic actuator in a second frequency range, the first frequency range including a resonance frequency of the reaction mass.

According to another embodiment of the invention, there is provided a lithographic apparatus including an illumination system configured to condition a radiation beam; a support constructed to support a patterning device, the patterning device being capable of imparting the radiation beam with a pattern in its cross-section to form a patterned radiation beam; a substrate table constructed to hold a substrate; and a projection assembly including a projection system configured to project the patterned radiation beam onto a target portion of the substrate, a damper configured to dampen a vibration of at least part of the projection system, the damper including an interface damping mass and an active damping subsystem configured to dampen a vibration of at least part of the interface damping mass, the interface damping mass being connected to the projection system, the active damping subsystem including a first sensor configured to measure a position quantity of the interface damping mass, an electromagnetic actuator configured to exert a force on the interface damping mass, and a controller configured to drive the electromagnetic actuator in dependency of signals provided by the first sensor, the active damping subsystem including a reaction mass for the electromagnetic actuator configured to exert a counterforce upon in dependency of a signal provided by the first sensor, wherein the controller is arranged to provide a substantially voltage control of the electromagnetic actuator in a first frequency range, and a substantially current control of the electromagnetic actuator in a second frequency range, the first frequency range including a resonance frequency of the reaction mass.

According to yet another embodiment of the invention, there is provided a lithographic apparatus including an illumination system configured to condition a radiation beam; a support constructed to support a patterning device, the patterning device being capable of imparting the radiation beam with a pattern in its cross-section to form a patterned radiation beam; a substrate table constructed to hold a substrate; a projection system configured to project the patterned radiation beam onto a target portion of the substrate; and a damper to dampen a vibration of at least part of the lithographic apparatus, the damper including a first sensor configured to measure a position quantity of the at least part of the lithographic apparatus, an electromagnetic actuator configured to exert a force on the at least part of the lithographic apparatus, and a controller configured to drive the electromagnetic actuator in dependency of a signal provided by the first sensor, the damper including a reaction mass for the electromagnetic actuator configured to exert a counterforce upon in dependency of a signal provided by the first sensor, wherein the controller is arranged to provide a substantially voltage control of the electromagnetic actuator in a first frequency range, and a substantially current control of the electromagnetic actuator in a second frequency range, the first frequency range including a resonance frequency of the reaction mass.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a schematic representation of a projection assembly according to another embodiment of the invention;

FIG. 3 depicts an example of the low frequency coupling between the reaction mass and interface damping mass in the projection assembly according to FIG. 2;

FIG. 4 depicts a schematic representation of a projection assembly according to yet another embodiment of the invention, and

FIG. 5 depicts a hardware implementation of a portion of the projection assembly according to FIG. 4 in accordance with an embodiment of the invention.

### DETAILED DESCRIPTION

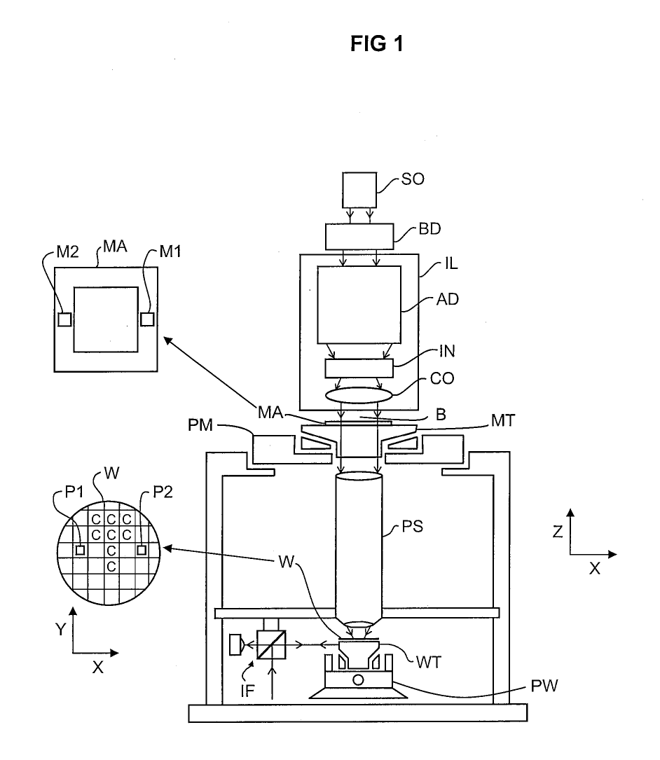

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support or support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the patterning device (e.g. mask) and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as a-outer and o-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the patterning device support (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the mask alignment marks may be located between the dies.

The depicted apparatus could be used in at least one of the following modes:

1. In step mode, the patterning device support (e.g. mask table) MT and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT and the substrate table WT or “substrate support” are scanned synchronously while a pattern imparted to the radiation beam is projected onto a target portion C (i.e. a single dynamic exposure). The velocity and direction of the substrate table WT or “substrate support” relative to the patterning device support (e.g. mask table) MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support (e.g. mask table) MT is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

Commonly, a damping system (also broadly termed “damper”) is provided to dampen vibrations of the projection system or parts thereof. Thereto, a damping system may be provided as known in many forms. The damping system may include an interface damping mass to absorb vibrations of at least part of the projection system, as well as an active damping subsystem to dampen a vibration of at least part of the interface damping mass. The interface damping mass is generally connected to the projection system. In this document, the term active damping system is to be understood as a damping system which includes a sensor to detect an effect of a vibration (e.g. a position sensor, velocity sensor, acceleration sensor, etc.) and an actuator to act on the structure to be damped or a part thereof, the actuator being driven by e.g. a controller in dependency of a signal provided by the sensor. By driving the actuator in dependency of the signal provided by the sensor, an effect of vibrations on the projection system and/or the interface damping mass connected therewith, may be reduced or cancelled to a certain extent. An example of such an active damping system may be provided by a feedback loop: the sensor to provide a position quantity, such as a position, speed, acceleration, jerk, etc of the interface damping mass or a part thereof, the controller being provided with the position quantity and generating a controller output signal to drive the actuator, the actuator in turn acting on the interface damping mass or the part thereof so that a feedback loop is provided. The controller may be formed by any type of controller and may be implemented in the software to be executed by a microprocessor, microcontroller, or any other programmable device, or may be implemented by dedicated hardware.

The actuator may be connected between a reaction mass of the active damping subsystem and the interface damping mass. It is noted that any other reaction body like a base frame of the lithographic apparatus or other reference may also be used for the actuator to exert its counterforces upon. The actuator may include any suitable type of actuator, such as a piezo electric actuator, a motor, etc. Preferably, use is made of an electromagnetic actuator such as a Lorentz actuator, as thereby a contactless actuator may be provided which does not provide for a mechanical contact between the reaction mass and the interface damping mass, as the Lorentz actuator may provide for a contactless exertion with respective parts connected to the reaction mass and the interface damping mass respectively. The reaction mass is usually low frequency coupled to the interface damping mass.

The force generated by the actuator that actually acts on the projection system through the interface damping mass is dictated by the low frequency coupling of the reaction mass to the interface damping mass, which is characterized by a resonance frequency of the reaction mass for which the reaction mass starts to oscillate. Only above the resonance frequency a force can be applied, because for frequencies below the resonance frequency the reaction mass moves instead of generating a force that actually acts on the projection system through the interface damping mass.

At the resonance frequency, the reaction mass starts to oscillate, thereby resulting in an undamped force on the projection system, and because the reaction mass is oscillating, its required movement is relatively large. To avoid this, two measures may be taken: (1) the feedback loop includes a high-pass filter to avoid excitation of the eigenfrequency, and (2) the resonance frequency is kept high enough, so that the reaction mass' movement range is limited. However, both measures have the effect that the lowest frequency for which the damping system can damp the projection system is relatively high and thus limit the bandwidth wherein internal resonances are prevented. A high bandwidth of the active damping system is desirable, as a high bandwidth of the active damping system will allow to suppress vibrations within such high bandwidth.

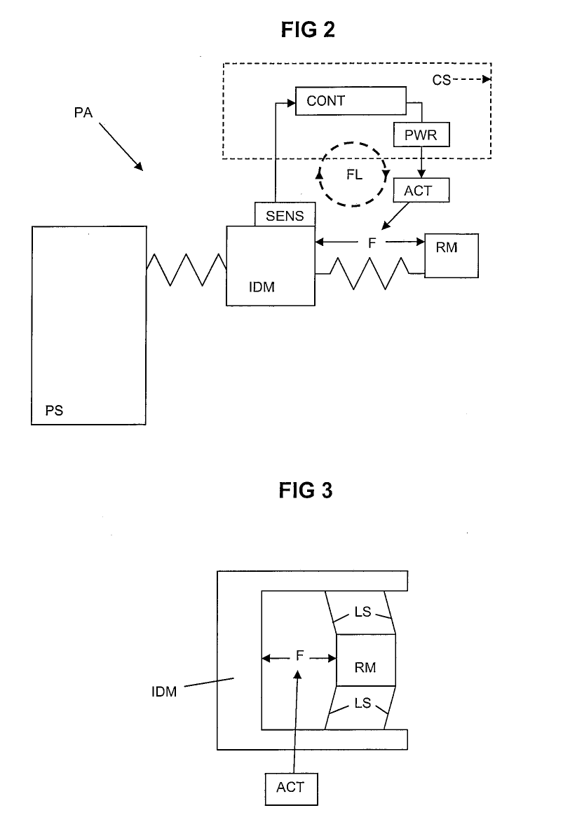

FIG. 2 depicts a schematic view of a projection assembly PA including a damping system (also broadly termed “damper”) in accordance with an embodiment of the invention. The projection assembly PA includes a projection system PS, which is configured to project a patterned radiation beam onto a target portion of a substrate (not shown, see for example FIG. 1). The projection system PS may be held in a metrology frame by any suitable device, e.g. including a rigid mounting, a resilient mounting, etc. The projection assembly PA also includes an interface damping mass IDM, which may include any object, preferably a rigid mass, and an active damping subsystem. The interface damping mass IDM is connected to the projecting system PS, and parts of the active damping subsystem can be connected to the interface damping mass IDM, such as sensors and actuators.

A vibration of the projection system PS results in a vibration of the interface damping mass IDM. Such vibration of the interface damping mass IDM is sensed by a sensor SENS of the active damping subsystem, which may include any type of vibration sensor, such as a position measurement sensor, a velocity measurement sensor, an acceleration measurement sensor, etc. An electromagnetic actuator ACT of the active damping subsystem is provided which acts on the interface damping mass IDM. In this embodiment, the actuator is connected between a reaction mass RM of the active damping subsystem and the interface damping mass IDM. Preferably, use is made of a Lorentz actuator, as thereby a contactless actuator may be provided which does not provide for a mechanical contact between the reaction mass RM and the interface damping mass IDM, as the Lorentz actuator may provide for a contactless exertion with respective parts connected to the reaction mass RM and the interface damping mass IDM respectively. However, other electromagnetic actuators, such as an iron core actuator, or a reluctance actuator, can also be used.

The actuator ACT is driven (e.g. using a suitable control system CS) in dependency of a signal provided by the sensor SENS. The control system or controller CS includes a controller CONT, the output signal of the sensor SENS providing an input signal to the controller CONT. The controller CONT generates a controller output signal to provide an input signal to a power source PWR. The power source PWR provides a drive signal based on the controller output signal to drive the actuator ACT. The actuator ACT in turn acts on the interface damping mass IDM or a part thereof by force F, so that a feedback loop FL is provided. The controller CONT may be formed by any type of controller and may be implemented in software to be executed by a microprocessor, microcontroller, or any other programmable device, or may be implemented by dedicated hardware.

The frequency behavior, as observed from the actuator ACT to the sensor SENS, is dominated by the interface damping mass IDM. It is preferred that the interface damping mass IDM forms a rigid body mass, at least in a frequency band of the active damping system, which will result in the sensor SENS and actuator ACT to observe a transfer function substantially corresponding to a rigid body mass. Effectively, as seen from the sensor SENS and actuator ACT, the resonant behavior of the projection system PS is masked by the presence of the interface damping mass IDM which is effectively interposed between the sensor SENS and actuator ACT on the one hand and the projection system PS on the other hand. As a consequence, a phase of the transfer function as of the frequency will show a more constant behavior, thereby possibly favoring a stable behavior of the active damping system including the sensor SENS and the actuator ACT.

The interface damping mass IDM may be connected to the projection system PS via a resilient connection, including e.g. a spring, such as a damped spring. Preferably the interface damping mass IDM is coupled with approximately 1-2 kHz to the projection system PS. Thereby, an effective decoupling of the vibrations and resonances of parts of the projection system PS may be provided.

The interface damping mass IDM may be connected to any relevant part of the projection system PS, in a practical implementation of a transmissive projection system, the damping mass may be connected to a lens mount (i.e. a mount for a plurality of lens elements thereof). In the case of a reflective projection system, the interface damping mass IDM may be connected e.g. to a frame holding one or more of the mirrors. Thereby, the projection system PS and its constituting parts may be effectively damped, as connecting the interface damping mass (and thereby indirectly connecting the active damping system) to the lens mount or frame will have effect on a plurality of constituting parts of the projection system, e.g. lens elements, mirrors, etc, as these constituting elements are all in turn connected to the lens mount or reference frame. In an alternative embodiment, it is also possible that the active damping subsystem is directly connected to the projection system, thereby eliminating the use of an interface damping mass. This can be beneficial in case little space is available for the system.

A mass of the interface damping mass IDM preferably is selected between about 0.001 and 0.1 times a mass of the projection system PS, more preferably between 0.001 and 0.01 times the mass of the projection system PS, as thereby the frequency of the interface damping mass IDM can be provided in a frequency range being within a desired bandwidth of the active damping system, thereby favoring a stable closed loop operation of the active damping system.

The reaction mass RM is low frequency coupled to the interface damping mass IDM via a spring. This low frequency coupling is characterized by a resonance frequency of the reaction mass RM. Above the resonance frequency of the reaction mass RM, the reaction mass RM will substantially be stationary when actuating the actuator ACT, and hence allows exerting a force on the projection system PS.

FIG. 3 depicts a schematic example of how the reaction mass RM can be low frequency coupled to the interface damping mass IDM. Between the reaction mass RM and the interface damping mass IDM, four leaf springs LS are provided in order to guide the reaction mass in a translational direction with respect to the interface damping mass IDM. The translational direction is substantially similar with the direction in which the actuator ACT exerts the force F. A benefit of the leaf springs LS is that they provide a substantially friction free bearing for the reaction mass RM. The combination of leaf springs LS and reaction mass RM defines a rigid body resonance frequency of the reaction mass RM in the translational direction. Other low-frequency coupling principles are also possible.

In FIG. 2, the control system CS is arranged to provide a substantially voltage control of the actuator ACT in a first frequency range, and a substantially current control of the actuator ACT in a second frequency range, the first frequency range including the resonance frequency of the reaction mass. The voltage control of the actuator ACT enables a damping current to be generated from a back-EMF voltage induced in the actuator ACT during the relative movement of the reaction mass RM with respect to the interface damping mass IDM. The damping current will dampen the movement of the reaction mass RM with respect to the interface damping mass IDM and thereby dampen the resonance frequency of the reaction mass RM. As a result, the controller CONT does not have to include an additional high-pass filter for the attenuation of the resonance frequency or a possibly present high-pass filter can be set to a lower cutoff frequency. In addition to this, the resonance frequency of the reaction mass RM can be lowered. It is now possible to decrease the lowest frequency for which the damping system can damp the projection system PS and thus increase the bandwidth of the damping system wherein internal resonances are prevented and vibrations may be reduced or cancelled to a certain extent.

Preferably the second frequency range does not overlap with the first frequency range. In an embodiment, the first frequency range includes the range from 0 Hz to a frequency above the resonance frequency, and the second frequency range is adjacent to the first frequency range. In this way, there is only one transition area between the two control types. The current control is preferably applied in a frequency range at least above an electric time constant of the actuator ACT, because the phase characteristics of the current control are better in the frequency range compared to voltage control.

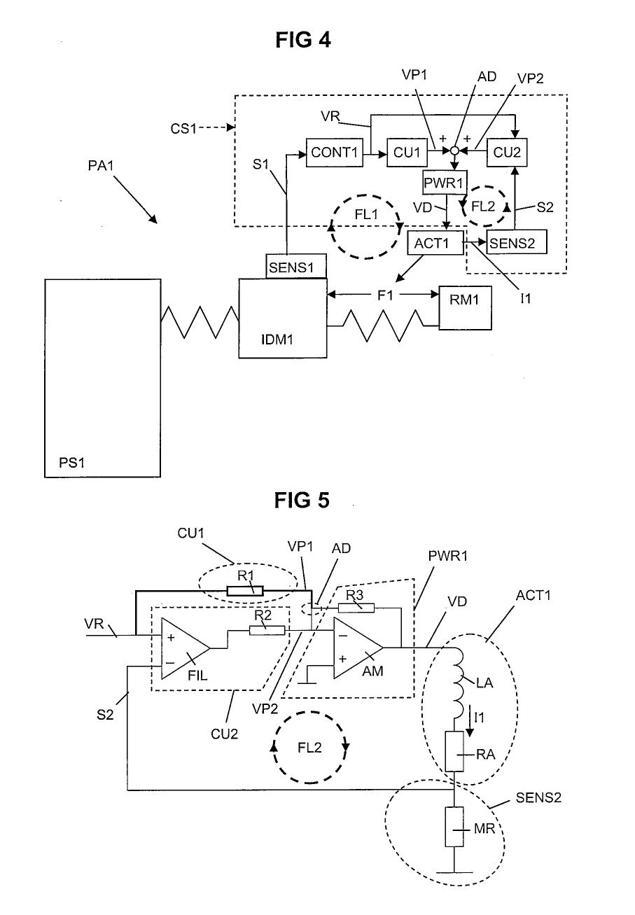

FIG. 4 depicts a projection assembly PA1 including a damping system (also broadly termed “damper”) according to another embodiment of the invention. The projection assembly PA1 includes a projection system PS1, an interface damping mass EDM1, and an active damping subsystem similar to the embodiment of FIG. 2. The interface damping mass IDM1 is connected to the projection system PS1, and parts of the active damping subsystem can be connected to the interface damping mass IDM1.

A vibration of the projection system PS1 results in a vibration of the interface damping mass IDM1. Such vibration of the interface damping mass IDM1 is sensed by a first sensor SENS1 of the active damping subsystem, which may include any type of vibration sensor, such as a position measurement sensor, a velocity measurement sensor, an acceleration measurement sensor, etc. An electromagnetic actuator ACT1 of the active damping subsystem is provided which acts on the interface damping mass IDM1. In this embodiment, the actuator ACT1 is connected between a reaction mass RM1 of the active damping subsystem and the interface damping mass IDM1. Preferably, the actuator ACT1 is a Lorentz actuator.

The actuator ACT1 is driven by a control system CS1. The control system or controller CS1 includes a controller CONT1, which is arranged to derive a reference signal VR from a sensor output S1 provided by the first sensor SENS1. Preferably, the reference signal VR is a measure for a force F1 that the control system CS1 aims to exert on the interface damping mass IDM1. The control system CS1 further includes a first control unit or controller CUL which is arranged to derive a first control signal VP1 based on the reference signal VR. The first control signal VP1 is supplied to an adding device or adder AD. The output of the adding device AD is provided to a power source PWR1, the power source PWR1 being arranged to apply a drive signal VD to the actuator ACT1. The actuator ACT1 in turn acts on the interface damping mass IDM1, so that a first feedback loop FL1 is provided.

The control system CS1 further includes a second sensor SENS2 to measure a current I1 that runs through the actuator ACT1 and which is a measure for the actual force F1 that is exerted on the interface damping mass IDM1. A sensor output S2 of the second sensor SENS2 is preferably proportional to the current I1. The control system CS1 also includes a second control unit or controller CU2 which is arranged to compare the sensor output S2 with the reference signal VR and derive a second control signal VP2 based on the difference between the sensor output S2 and the reference signal VR. The second control signal VP2 is supplied to the adding device AD to be combined with the first control signal VP1. The output of the adding device AD is provided to the power source PWR1, the power source PWR1 thereby providing a drive signal VD to the actuator ACT1 based on the combination of the first control signal VP1 and the second control signal VP2, so that a second feedback loop FL2 is provided. The second feedback loop FL2 aims to provide an actual force F1 that is substantially corresponding to the desired force, represented by reference signal VR.

The drive signal VD is preferably a voltage signal. In the absence of the second feedback loop FL2, the actuator ACT1 would be entirely voltage controlled. A relative movement between the reaction mass RM1 and the interface damping mass IDM1 is able to induce a voltage in the actuator ACT1. Because the first feedback loop FL1 will not compensate for the induced voltage, voltage control allows a damping current to flow due to the induced voltage, thereby dampening the relative movement between the reaction mass RM1 and the interface damping mass IDM1.

The second feedback loop FL2 is configured to provide a current I1 through the actuator ACT1 which substantially corresponds to the reference signal VR. An induced voltage in the actuator ACT1 will thus be mainly compensated by the second feedback loop FL2 by applying an appropriate second control signal VP2, which combined with the first control signal VP1 will result in the desired current I1. Therefore, current control will not allow a damping current to flow due to the induced voltage and will thus not dampen the relative movement between the reaction mass RM1 and the interface damping mass IDM1.

In principle, current control dominates over voltage control when combined. The second control unit CU2 is therefore arranged such that the influence of the second feedback loop FL2 is reduced in the first frequency range, so that the actuator ACT1 is mainly voltage controlled. In this embodiment, the second control unit CU2 therefore includes a high-pass filter (not shown) to filter the difference between the reference signal VR and the sensor output S2, thereby attenuating the difference between the reference signal VR and the sensor output S2 in the first frequency range.

A benefit of this embodiment is that the resonance frequency of the reaction mass RM1, which is in the first frequency range, is damped, such that the controller CONT1 does not have to include an additional high-pass filter for the attenuation of the resonance frequency or that a possibly present high-pass filter can be set to a lower cutoff frequency. In addition to this, the resonance frequency of the reaction mass RM1 can be lowered. It is now possible to decrease the lowest frequency for which the damping system can damp the projection system PS1 and thus increase the bandwidth of the damping system wherein internal resonances are prevented and vibrations may be reduced or cancelled to a certain extent.

FIG. 5 depicts a possible hardware implementation of a portion of the control system or controller CS1 according to FIG. 4. For simplicity reasons, similar parts have similar reference numerals. The actuator ACT1 is here represented by an inductance LA of the actuator ACT1 in series with a resistor RA of the actuator ACT1. As second sensor SENS2 is provided a measurement resistor MR in series with the actuator ACT1. Preferably, the measurement resistor MR is small compared to the impedance of the actuator ACT1, thereby minimizing a measurement error due to the presence of the measurement resistor MR in the circuit. Most of, and preferably all of the current I1 that runs through the actuator ACT1 will run through the measurement resistor MR, thereby providing a sensor output S2 substantially proportional to the current I1. In this case, the sensor output S2 is a voltage.

The first control unit CU1 includes a resistor R1 which converts the reference signal VR1, which in this example is a voltage, into a current which is represented by first control signal VP1.

The sensor output VS2 is compared with the reference voltage VR by control unit CU2 including a filter FIL and a resistor R2. In this example, the filter FIL is an operational amplifier having filter components such as resistors, capacitors, and inductors, which for simplicity reasons are not shown in this Figure. The second control unit CU2 provides second control signal VP2, here as a current through resistor R2. A skilled person in the art is well familiar with filters including operational amplifiers.

The first control signal VP1 and the second control signal VP2 are combined at the point AD; and the combination of the two currents is supplied to the power source PWR1 including a power operational amplifier AM and a resistor R3. The power source PWR1 provides a drive signal VD, in this example a voltage, such that the appropriate current I1 runs through the actuator ACT1.

In this example, the main components are resistors and operational amplifiers, but other hardware components can also be used, such as the use of transistors, capacitors, inductors, and microcontrollers. Preferably, resistors R2 and R3 are substantially equal and resistor R1 is equal to R3 divided by RA.

The filter FIL is preferably a high-pass filter to filter the difference between the reference signal VR and the sensor output S2 in a first frequency range, thereby attenuating the difference between the reference signal VR and the sensor output S2 for low frequencies. The drive signal VD of the power source PWR1 is then for low frequencies mainly based on the reference signal VR and the influence of the second feedback loop FL2 is then greatly reduced in the first frequency range. This results in a voltage control of the actuator in the first frequency range.

The filter will not or only partially attenuate the difference between the reference signal VR and the sensor output S2 in a second frequency range, which is preferably adjacent to the first frequency range. The drive signal VD will then be mainly based on the combination of the first control signal and the second control signal, thereby allowing control of the current through the actuator ACT1. The actuator ACT1 is then mainly current controlled in the second frequency range.

It is noted that the above described systems are not limited to dampen a vibration of a projection system only. A damping system or damper according to an embodiment of the invention can also be used to dampen a vibration of at least part of a lithographic apparatus, such as a metrology frame, base frame, or any other part, including the projection system. In that case, the damping system is connected to the at least part of the lithographic apparatus. The damping system includes a combination of a first sensor to measure a position quantity of the at least part of the lithographic apparatus, an electromagnetic actuator to exert forces on the at least part of the lithographic apparatus, and a control system to drive the electromagnetic actuator in dependency of signals provided by the first sensor. The damping system further includes a reaction mass for the electromagnetic actuator to exert counterforces upon in dependency of signals provided by the first sensor. The control system is arranged to provide a substantially voltage control of the electromagnetic actuator in a first frequency range, and a substantially current control of the electromagnetic actuator in a second frequency range, the first frequency range including a resonance frequency of the reaction mass.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A projection assembly comprising:
a projection system configured to project a patterned radiation beam onto a target portion of a substrate;
a damper configured to dampen a vibration of at least part of the projection system, the damper comprising an interface damping mass and an active damping subsystem configured to dampen a vibration of at least part of the interface damping mass, the interface damping mass being connected to the projection system, the active damping subsystem comprising
a first sensor configured to measure a position quantity of the interface damping mass,
an electromagnetic actuator configured to exert a force on the interface damping mass,
a controller configured to drive the electromagnetic actuator in dependency of a signal provided by the first sensor,
a reaction mass for the electromagnetic actuator to exert a counterforce upon in dependency of the signal provided by the first sensor,
wherein the controller is arranged to provide a substantially voltage control of the electromagnetic actuator in a first frequency range, and a substantially current control of the electromagnetic actuator in a second frequency range, the first frequency range comprising a resonance frequency of the reaction mass.

2. The projection assembly according to claim 1, wherein the active damping subsystem comprises a first feedback loop to provide the voltage control and a second feedback loop to provide the current control.

3. The projection assembly according to claim 2, wherein the first feedback loop comprises:
the electromagnetic actuator configured to exert the force on the interface damping mass based on a drive signal,
the first sensor,
a controller arranged to derive a reference signal based on the signal provided by the first sensor,
a first control unit arranged to derive a first control signal based on the reference signal,
an adder configured to combine the first control signal and a second control signal, and
a power source arranged to apply the drive signal based on the combination of the first control signal and the second control signal,
and wherein the second feedback loop comprises:
the electromagnetic actuator,
a second sensor configured to measure a current through the electromagnetic actuator,
a second control unit arranged to derive the second control signal based on the difference between the reference signal and the signal provided by the second sensor,
the adder, and
the power source.

4. The projection assembly according to claim 3, wherein the second control unit comprises a high-pass filter configured to filter a difference between the reference signal and the signal provided by the second sensor so as to attenuate the difference between the reference signal and the signal provided by the second sensor in the first frequency range.

5. The projection assembly according to claim 1, wherein the electromagnetic actuator is a Lorentz actuator.

6. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate; and
a projection assembly comprising a projection system configured to project the patterned radiation beam onto a target portion of the substrate and a damper configured to dampen a vibration of at least part of the projection system, the damper comprising an interface damping mass and an active damping subsystem configured to dampen a vibration of at least part of the interface damping mass, the interface damping mass being connected to the projection system, the active damping subsystem comprising
a first sensor configured to measure a position quantity of the interface damping mass,
an electromagnetic actuator configured to exert a force on the interface damping mass,
a controller configured to drive the electromagnetic actuator in dependency of a signal provided by the first sensor, and
a reaction mass for the electromagnetic actuator to exert a counterforce upon in dependency of the signal provided by the first sensor,
wherein the controller is arranged to provide a substantially voltage control of the electromagnetic actuator in a first frequency range, and a substantially current control of the electromagnetic actuator in a second frequency range, the first frequency range comprising a resonance frequency of the reaction mass.

7. The lithographic apparatus according to claim 6, wherein the active damping subsystem comprises a first feedback loop to provide the voltage control and a second feedback loop to provide the current control.

8. The lithographic apparatus according to claim 7, wherein the first feedback loop comprises:
the electromagnetic actuator configured to exert the force on the interface damping mass based on a drive signal,
the first sensor,
a controller arranged to derive a reference signal based on the signal provided by the first sensor,
a first control unit arranged to derive a first control signal based on the reference signal,
an adder configured to combine the first control signal and a second control signal, and
a power source arranged to apply the drive signal based on the combination of the first control signal and the second control signal,
and wherein the second feedback loop comprises:
the electromagnetic actuator,
a second sensor configured to measure a current through the electromagnetic actuator,
a second control unit being arranged to derive the second control signal based on a difference between the reference signal and the signal provided by the second sensor,
the adder, and
the power source.

9. The lithographic apparatus according to claim 8, wherein the second control unit comprises a high-pass filter configured to filter the difference between the reference signal and the signals provided by the second sensor so as to attenuate the difference between the reference signal and the signal provided by the second sensor in the first frequency range.

10. The lithographic apparatus according to claim 6, wherein the electromagnetic actuator is a Lorentz actuator.

11. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate;
a projection system configured to project the patterned radiation beam onto a target portion of the substrate; and
a damper configured to dampen a vibration of at least part of the lithographic apparatus, the damper comprising
a first sensor configured to measure a position quantity of the at least part of the lithographic apparatus,
an electromagnetic actuator configured to exert a force on the at least part of the lithographic apparatus,
a controller configured to drive the electromagnetic actuator in dependency of a signal provided by the first sensor, and
a reaction mass for the electromagnetic actuator configured to exert a counterforce upon in dependency of the signal provided by the first sensor,
wherein the controller is arranged to provide a substantially voltage control of the electromagnetic actuator in a first frequency range, and a substantially current control of the electromagnetic actuator in a second frequency range, the first frequency range comprising a resonance frequency of the reaction mass.

12. The lithographic apparatus according to claim 11, wherein the damper comprises a first feedback loop to provide the voltage control and a second feedback loop to provide the current control.

13. The lithographic apparatus according to claim 12, wherein the first feedback loop comprises:
the electromagnetic actuator to exert the force on the at least part of the lithographic apparatus based on a drive signal,
the first sensor,
a controller arranged to derive a reference signal based on the signal provided by the first sensor,
a first control unit being arranged to derive a first control signal based on the reference signal,
an adder configured to combine the first control signal and a second control signal, and
a power source being arranged to apply the drive signal based on the combination of the first control signal and the second control signal,
and wherein the second feedback loop comprises:
the electromagnetic actuator,
a second sensor configured to measure a current through the electromagnetic actuator,
a second control unit arranged to derive the second control signal based on the difference between the reference signal and the signal provided by the second sensor,
the adding device, and
the power source.

14. The lithographic apparatus according to claim 13, wherein the second control unit comprises a high-pass filter configured to filter the difference between the reference signal and the signals provided by the second sensor so as to attenuate the difference between the reference signal and the signal provided by the second sensor in the first frequency range.

15. The lithographic apparatus according to claim 11, wherein the electromagnetic actuator is a Lorentz actuator.
